(19) United States
(12) Patent Application Publication
(10) Pub. No.: US 2025/0240724 A1
(43) Pub. Date: Jul. 24, 2025

(54) CATEGORY-BASED DISCOVERY FOR DEVICES IN DEEP SLEEP

(71) Applicant: Telefonaktiebolaget LM Ericsson (publ), Stockholm (SE)

(72) Inventors: Fredrik Dahlgren, Lund (SE); Bipin Balakrishnan, Kävlinge (SE); Gang Zou, Lund (SE); Saeed Bastani, Dalby (SE)

(21) Appl. No.: 18/849,520

(22) PCT Filed: Mar. 23, 2022
(86) PCT No.: PCT/EP2022/057682

§ 371 Date: Sep. 22, 2024

(51) Int. Cl. H04W 52/02

(52) U.S. Cl. CPC H04W 52/0235; H04W 52/0219

(57) ABSTRACT

Systems and methods are disclosed for category-based wake-up and discovery for devices in deep sleep. In one embodiment, a method performed by a radio node comprises determining a category of User Equipments (UEs) to be woken-up, where the category of UEs is one of a plurality of predefined or preconfigured categories of UE. The method further comprises generating a category wake-up signal (C-WUS) that is indicative of the category of UEs to be woken-up and broadcasting the C-WUS. In this manner, targeted discovery procedure can be performed for UEs that are in deep sleep and belong to a particular category such that energy is noted wasted on other UEs that are in deep sleep but do not belong to the particular category.

### TECHNICAL FIELD

The present disclosure relates to a wireless network and, more specifically, to discovery of wireless communication devices (e.g., User Equipments (UEs)) that are in deep sleep.

### BACKGROUND

Relay-connections using sidelink or Device-to-Device (D2D) communication has been presented in order to increase the wireless communication coverage in situations where the Radio Frequency (RF) link between a Base Station (BS) and a User Equipment (UE) may be very poor or totally lost. For example, see Third Generation Partnership Project (3GPP) Long Term Evolution (LTE) D2D Proximity Services (ProSe) and an associated study in 3GPP Technical Report (TR) 36.843 entitled “Study on LTE Device to Device Proximity Services—Radio Aspects.”

On the other hand, wake-up signaling has been proposed to enable UEs to go into deep sleep and the BS to wake up the UEs with certain signaling. For example, the 3GPP LTE cellular network uses a Wake-Up Signal (WUS) to wake up Internet-of-Things (IoT) UEs. This WUS is transmitted from a BS to IoT UEs that are in idle mode (e.g., deep sleep) and required to decode the Physical Downlink Control Channel (PDCCH) in paging occasions (see, e.g., 3GPP Technical Specification (TS) 36.211 V16.1.0). In those cases, an IoT UE needs wake up to perform time and frequency synchronization, receive and decode the WUS, and further receive and decode the paging information carried in a PDCCH if the IoT finds the WUS is targeting itself. As the distance between the BS and the IoT UE is generally long, the WUS is often transmitted with a certain RF bandwidth and/or encoded in time or frequency domain to lower its miss-detection rate.

For ultra-low-power IoT devices, e.g. wireless sensors, placing relay nodes is one approach to extend cellular network coverage over them. For instance, Cheng, X., Du, D Z., Wang, L. et al. Relay sensor placement in wireless sensor networks. Wireless Network 14, 347-355 (2008). https://doi.org/10.1007/s11276-006-0724-8 (hereinafter referred to as the “Cheng Article”) proposed a solution to place relay nodes in a wireless sensor network. All the wireless sensors can be connected to the relay nodes, which are more powerful and able to transfer data over long distance.

International Patent Application Publication No. WO2021013337A1 entitled “Handling of paging messages in communication endpoint to network relaying scenarios” proposes a method for a relay terminal (i.e., a relay UE) connected to a mobile access entity of cellular network system that involves selecting a sidelink communication group from a set of configured sidelink communication groups for a terminal (i.e., a UE) to be relayed by the relay UE. It is about group paging occasions to a group of remote terminals by a relay terminal. The relay terminal also provides sidelink synchronization for these groups of remote terminals. Though paging occasions signaling via the relay terminal may appear similar to a WUS, the details are different. In paging occasions, the signal is transmitted when the terminal is powered and, when the terminal goes to sleep, the paging occasion is the time when the terminal should wake up and check the network signaling.

International Patent Application Publication No. WO2021114008 A1 entitled “Wake-up signal techniques in wireless communications” deals with wake-up protocols in relay scenarios. The focus is on a system with a relay UE and one or multiple remote UEs. The relay UE can go in low power mode and then be woken up by one or several of the remote UEs. Different scenarios are presented for how the relay UE or remote UE first sends a Synchronization Signal Block (SSB) to define which slots should be for the WUS so the relay UE, when in low-power mode, needs only to listen at those slots. The remote UEs can either have separate slots, as defined in the SSB, or share slots. SSB messages can be either to a single UE or sent via broadcast or multicast. However, the UEs are not in deep sleep but are regularly active to listen to signaling in the slots indicated by the SSB.

United States Patent Application Publication No. US2021058866 A1 entitled “Power-saving techniques for sidelink communication” is about power saving mechanisms in sidelink communications. It focuses on WUS for one-to-one scenarios. It mentions the possibility of sending WUS to multiple UEs, but there is no description on how this is done. It is not clear whether the WUS is forwarded by a BS or a relay UE.

Mechanisms and concepts are proposed in a concurrently filed patent application by the inventors of the present patent application for increasing efficiency by employing group wake-up as well as hierarchical wake-up. In group wake-up, the relay UE wakes up a group of remote UEs, either by an explicit request from the BS or because it is acting as a proxy for certain services and identifies the need to wake them up. Furthermore, in some embodiments, the relay UE checks if each individual remote UE is woken up and establishes time-synchronization.

### SUMMARY

Systems and methods are disclosed for category-based wake-up and discovery for devices in deep sleep. In one embodiment, a method performed by a radio node comprises determining a category of User Equipments (UEs) to be woken-up, where the category of UEs is one of a plurality of predefined or preconfigured categories of UE. The method further comprises generating a category wake-up signal (C-WUS) that is indicative of the category of UEs (104) to be woken-up and broadcasting the C-WUS. In this manner, targeted discovery procedure can be performed for UEs that are in deep sleep and belong to a particular category such that energy is not wasted on other UEs that are in deep sleep but do not belong to the particular category.

In one embodiment, one or more characteristics of the C-WUS are indicative of the category of UEs to be woken-up.

In one embodiment, a waveform of the C-WUS is indicative of the category of UEs to be woken-up.

In one embodiment, the C-WUS is encoded or modulated with a category identifier (ID) of the category of UEs to be woken-up.

In one embodiment, the plurality of predefined or preconfigured categories of UEs comprise a plurality of functional categories of UEs. In one embodiment, the one or more functional categories of UEs comprise: (a) one or more media-related categories, (b) one or more building-related measurement sensor categories, (c) one or more lock categories, (d) one or more home automation categories, (e) one or more Information Technology (IT) peripheral categories, or (f) a combination of any two or more of (a)-(e).

In one embodiment, the plurality of predefined or preconfigured categories of UEs comprise a plurality of service categories of UEs. In one embodiment, the one or more service categories of UEs (104) comprise: (i) one or more audio playback categories, (ii) one or more energy measurement categories, (iii) one or more pollution measurement categories, (iv) one or more computer support categories, or (v) a combination of any two or more of (i)-(iv).

In one embodiment, the plurality of predefined or preconfigured categories of UEs comprise a plurality of device type categories. In one embodiment, the one or more device type categories comprise: (A) a category of devices with ultra-low power, (B) a category of devices with low wake-up latency, low bit-rate, and frequent wake-up category, (C) a category of devices with long operational activity but long deep-sleep periods, or (D) a combination of any two or more of (A)-(C).

In one embodiment, the plurality of predefined or preconfigured categories of UEs comprises one or more vendor categories, one or more service provider categories, or one or more user or owner categories.

In one embodiment, the plurality of predefined or preconfigured categories of UEs comprises one or more third-party defined categories.

In one embodiment, the C-WUS is unique to the category of UEs to be woken-up.

In one embodiment, the method further comprises monitoring for wake-up acknowledgments (W-ACKs) from UEs woken-up by the C-WUS. In one embodiment, monitoring for the W-ACKs comprising monitoring for the W-ACKs for up to a predefined or preconfigured wait time. In one embodiment, the method further comprises receiving W-ACKs from UEs woken-up by the C-WUS.

In one embodiment, the method further comprises generating a group wake-up signal (G-WUS) that is indicative of a group of UEs where the group of UEs is one of a plurality of predefined or preconfigured groups, and broadcasting the G-WUS. In one embodiment, one or more characteristics of the G-WUS are indicative of the group. In one embodiment, a waveform of the G-WUS is indicative of the group. In one embodiment, the G-WUS is encoded with a group ID of the group of UEs. In one embodiment, the method further comprises monitoring for W-ACKs from UEs woken-up by the C-WUS and the G-WUS, the UEs woken-up by the C-WUS and the G-WUS being only those UEs that are both within the category and within the group. In one embodiment, monitoring for the W-ACKs comprising monitoring for the W-ACKs for up to a predefined or preconfigured wait time. In one embodiment, the method further comprises receiving W-ACKs from UEs woken-up by the C-WUS and the G-WUS.

In one embodiment, the method further comprises adding the UEs from which the W-ACKs are received to a candidate list of UEs, selecting one or more preferred UEs from the candidate list of UEs, sending a connection request to each of the one or more preferred UEs, and receiving a connection accept from at least one of the one or more preferred UEs.

In one embodiment, the radio node is a base station in a cellular communications system, and the UEs are UEs in the cellular communications system.

In one embodiment, both the radio node and the UEs are UEs in a cellular communications system.

In one embodiment, both the radio node and the UEs are Bluetooth or IEEE 802.11 devices.

Corresponding embodiments of a radio node are also disclosed. In one embodiment, a radio node is adapted to determine a category of UEs to be woken-up, the category of UEs being one of a plurality of predefined or preconfigured categories of UEs. The radio node is further adapted to generate a C-WUS that is indicative of the category of UEs to be woken-up and broadcast the C-WUS. In one embodiment, the radio node performs the aforementioned procedure to wake-up multiple categories of UEs, e.g., simultaneously.

In one embodiment, a radio node comprises one or more transmitters, one or more receivers, and processing circuitry associated with the one or more transmitters and the one or more receivers. The processing circuitry is configured to cause the radio node to determine a category of UEs to be woken-up, the category of UEs being one of a plurality of predefined or preconfigured categories of UEs. The processing circuitry is further configured to cause the radio node to generate a C-WUS that is indicative of the category of UEs to be woken-up and broadcast the C-WUS.

Embodiments of a method performed by a UE are also disclosed. In one embodiment, a method performed by a UE comprises, while in a deep sleep state, detecting a C-WUS from a radio node, the C-WUS being indicative of a category of UEs in which the UE is included. The method further comprises performing one or more actions responsive to detecting the C-WUS.

In one embodiment, one or more characteristics of the C-WUS are indicative of the category of UEs in which the UE is included.

In one embodiment, a waveform of the C-WUS is indicative of the category of UEs in which the UE is included.

In one embodiment, the C-WUS is encoded or modulated with a category ID of the category of UEs in which the UE is included.

In one embodiment, the category of UEs is one of a plurality of predefined or preconfigured categories of UEs. In one embodiment, the plurality of predefined or preconfigured categories of UEs comprise a plurality of functional categories of UEs. In one embodiment, the one or more functional categories of UEs (104) comprise: (a) one or more media-related categories, (b) one or more building-related measurement sensor categories, (c) one or more lock categories, (d) one or more home automation categories, (e) one or more IT peripheral categories, or (f) a combination of any two or more of (a)-(e).

In one embodiment, the plurality of predefined or preconfigured categories of UEs comprise a plurality of service categories of UEs. In one embodiment, the one or more service categories of UEs comprise: (i) one or more audio playback categories, (ii) one or more energy measurement categories, (iii) one or more pollution measurement categories, (iv) one or more computer support categories, or (v) a combination of any two or more of (i)-(iv).

In one embodiment, the plurality of predefined or preconfigured categories of UEs comprise a plurality of device type categories. In one embodiment, the one or more device type categories comprise: (A) a category of devices with ultra-low power, (B) a category of devices with low wake-up latency, low bit-rate, and frequent wake-up category, (C) a category of devices with long operational activity but long deep-sleep periods, or (D) a combination of any two or more of (A)-(C).

In one embodiment, the plurality of predefined or preconfigured categories of UEs comprises one or more vendor categories, one or more service provider categories, or one or more user or owner categories.

In one embodiment, the plurality of predefined or preconfigured categories of UEs comprises one or more third-party defined categories.

In one embodiment, the C-WUS is unique to the category of UEs.

In one embodiment, performing the one or more actions responsive to detecting the C-WUS comprises transitioning from the deep sleep state to an active state and transmitting a W-ACK to the radio node.

In one embodiment, performing the one or more actions responsive to detecting the C-WUS comprises monitoring for a G-WUS for a group of UEs in which the UE is included, detecting the G-WUS, transitioning from the deep sleep state to an active state responsive to detecting the G-WUS, and transmitting a W-ACK to the radio node.

In one embodiment, performing the one or more actions responsive to detecting the C-WUS comprises monitoring for a G-WUS for a group of UEs in which the UE is included where the monitoring is performed for a predefined or preconfigured amount of time, failing to detect a G-WUS for the group of UEs in which the UE is included within the predefined or preconfigured amount of time, and returning to the deep sleep state responsive to failing to detect a G-WUS for the group of UEs in which the UE is included within the predefined or preconfigured amount of time.

In one embodiment, the method further comprises, after transmitting the W-ACK, monitoring for a connection request from the radio node. In one embodiment, monitoring for a connection request from the radio node comprises monitoring for a connection request from the radio node for up to a predefined or preconfigured amount of time. In one embodiment, the method further comprises receiving a connection request from the radio node and transmitting a response to the connection request to the radio node.

In one embodiment, monitoring for a connection request from the radio node comprises monitoring for a connection request from the radio node for up to a predefined or preconfigured amount of time, determining that a connection request is not received from the radio node within the predefined or preconfigured amount of time, and returning to a deep sleep mode upon determining that a connection request is not received from the radio node within the predefined or preconfigured amount of time.

Corresponding embodiments of a UE are also disclosed. In one embodiment, a UE is adapted to, while in a deep sleep state, detect a C-WUS from a radio node, the C-WUS being indicative of a category of UEs in which the UE is included. The UE is further adapted to perform one or more actions responsive to detecting the C-WUS.

In one embodiment, a UE comprises one or more transmitters, one or more receivers, and processing circuitry associated with the one or more transmitters and the one or more receivers. The processing circuitry is configured to cause the UE to, while in a deep sleep state, detect a C-WUS from a radio node, the C-WUS being indicative of a category of UEs in which the UE is included. The processing circuitry is further configured to cause the UE to perform one or more actions responsive to detecting the C-WUS.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a system in which embodiments of the present disclosure may be implemented;

FIG. 2 shows an example of device identity (ID) consisting of category ID, group ID, and individual ID in accordance with one embodiment of the present disclosure;

FIGS. 3A and 3B illustrate a category-based wake-up and discovery procedure in accordance with one embodiment of the present disclosure;

FIG. 4 is a flow chart that illustrates the operation of a radio node in accordance with one embodiment of the present disclosure;

FIG. 5 is a flow chart that illustrates the operation of a UE in accordance with one embodiment of the present disclosure;

FIGS. 6 and 7 illustrate one example of the multiple level wake-up scheme in accordance with one embodiment of the present disclosure;

FIG. 8 is a schematic block diagram of a Radio Access Network (RAN) node according to some embodiments of the present disclosure;

FIG. 9 is a schematic block diagram that illustrates a virtualized embodiment of the RAN node of FIG. 8 according to some embodiments of the present disclosure;

FIG. 10 is a schematic block diagram of the RAN node of FIG. 8 according to some other embodiments of the present disclosure;

FIG. 11 is a schematic block diagram of a User Equipment (UE) according to some embodiments of the present disclosure;

FIG. 12 is a schematic block diagram of the UE of FIG. 11 according to some other embodiments of the present disclosure;

FIG. 13 illustrates a telecommunication network connected via an intermediate network to a host computer in accordance with some embodiments of the present disclosure;

FIG. 14 is a generalized block diagram of a host computer communicating via a base station with a UE over a partially wireless connection in accordance with some embodiments of the present disclosure;

FIG. 15 is a flowchart illustrating a method implemented in a communication system in accordance with one embodiment of the present disclosure;

FIG. 16 is a flowchart illustrating a method implemented in a communication system in accordance with one embodiment of the present disclosure;

FIG. 17 is a flowchart illustrating a method implemented in a communication system in accordance with one embodiment of the present disclosure; and

FIG. 18 is a flowchart illustrating a method implemented in a communication system in accordance with one embodiment of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a User Equipment (UE).

Radio Access Node: As used herein, a “radio access node” or “radio network node” or “radio access network node” or “RAN node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

User Equipment (UE): One type of communication device is a UE, which herein refers to any wireless communication device that has access to (i.e., is served by) a wireless network (e.g., a cellular network). Some examples of a wireless communication device include, but are not limited to: a 3GPP UE (i.e., a UE in a 3GPP network), a Machine Type Communication (MTC) device (also referred to herein as a MTC UE, and an Internet of Things (IoT) device (also referred to herein as an IoT UE). Such UEs may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The UE may be a portable, hand-held, computer-comprised, or vehicle-mounted mobile device, enabled to communicate voice and/or data via a wireless connection.

Relay UE: As used herein, a “relay UE” is a UE that, in addition to having communication to/from a RAN node (e.g., a base station), can also have communication to and from another UE, for example, via a D2D link or 3GPP sidelink. This other UE is referred to herein as a “remote UE”. Furthermore, a relay UE can receive and transmit data and control signals on behalf of the remote UE(s) to which it has a direct communication link. The relay UE is in proximity of one or more remote UEs.

Remote UE: As used herein, a “remote UE” is a UE that is capable of both D2D or sidelink communication to the relay UE and direct communication to a base station. Typically, the remote UE is power constrained. The remote UE operates in a deep-sleep mode of operation (e.g., 3GPP idle mode) and be woken up by a wake-up signal. Sometimes in the present disclosure, the term “sensor UE” or “sensor node” is used to denote a type of remote UE that is extremely power constrained.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Embodiments of the present disclosure focus on a scenario in which there is potentially a large number of UEs in deep sleep, where some of these UEs might be stationary and others have been moved into an area while in deep sleep. When a device or service function needs to know if there is any UE in the area relevant for a certain function or service, a discovery procedure is typically performed. This is the case in, e.g., a Bluetooth® network where all Bluetooth® devices in reachable distance that are in a state supporting discovery indicate their identity. However, such discovery procedures are based on the fact that those devices are active and listening for a discovery request so they can respond. Devices in deep sleep would not react on such requests. It might be possible to send a Wake-Up Signal (WUS) to all devices in deep sleep so they wake up and can participate in a discovery procedure, which would be in line with existing deep sleep solutions. However, that would mean that devices that are not at all related to the specific service or function for which discovery is being required would be woken-up. As a result, a significant amount of battery power of such devices would be wasted due to many unnecessary wake-ups. Some devices might be ultra-low power, with a small battery whose charge should last a long period of time (e.g., a year or more), and it is imperative that such devices are not woken-up unless needed.

Based on the group wake-up mechanism described in the concurrently filed patent application by the inventor of the present patent application, a group of UEs can be defined for UEs belonging to certain functions or otherwise being relevant for certain other devices. However, those groups need to be defined while the UEs are active, and their identities need to be understood by some instance in the surrounding so they can be woken up as a group. This is not the case in the above scenario where the set of deep sleep UEs in an area is not known (e.g., some might have been moved into that area while in deep sleep), and for some functions it would be relevant to perform a discovery procedure for UEs reachable by a certain device.

Systems and methods are disclosed herein to address the aforementioned and/or other problems with existing wake-up mechanisms. Embodiments are disclosed herein for a category-based wake-up signaling scheme that provides wake-up of only those UEs belonging to a specific category are woken-up but no other. Some non-limiting examples of a category are: measuring sensors in a house, headphones, mouse, gas sensor, and lock (e.g., on a door). Embodiments of a discovery procedure and embodiments of a mechanism enabling discovery of relevant UEs belonging to a certain category in an area even if those UEs are in deep sleep are disclosed. The discovery procedure does not wake-up UEs that do not belong to the certain category.

In the embodiments disclosed herein, there need not be any prior knowledge on exactly which UEs are currently in the area. Furthermore, deep sleep UEs not related to a certain category of UEs being woken-up (or discovered) will not waste unnecessary energy in wake-up cycles due to discovery or wake-up of other types of UEs in the same area.

In some embodiments, UEs belonging to a certain category might have similar characteristics, e.g. bitrate and latency needs, allowing the category to enable relaxed wake-up schemes meeting their demands (but not much more) leading to more optimized wake-up procedures.

Furthermore, as a discovery procedure might indicate the presence of multiple UEs of a certain category, of which only one might be wanted or needed, a two-step procedure is also proposed in order to further minimize energy waste for UEs that will not be selected and become operational.

Two aspects of embodiments disclosed herein are the following:
A category-based wake-up signaling scheme and mechanism enabling the wake-up of only devices of a certain category (without knowing their device identities (IDs) or presence before-hand), which avoids wasted energy because of wake-up of devices not belonging to that category.
Discovery procedures and mechanisms for devices in deep sleep without leading to wasted energy in devices not relevant for the requested function, services, or type of devices. This can extend other types of discovery procedures and mechanisms for, e.g., Bluetooth, but with support for devices in deep sleep.

While not being limited to or by any particular advantage, embodiments of the present disclosure may provide a number of advantages over existing wake-up mechanisms. For example, embodiments of the present disclosure may provide the opportunity to perform a discovery procedure including devices under deep sleep without having to waste energy in deep-sleep devices not relevant for the requested function, service, or device type. Embodiments of the present disclosure may enable previously unidentified deep-sleep devices to be identified and then to include these in a defined group for group-wake. Embodiments of the present disclosure may be used to complement the discovery procedure in Bluetooth in that they can involve devices in deep sleep, which is not possible with Bluetooth today. Embodiments of the present disclosure may be used for 3GPP communication schemes but can also be used for non-3GPP short-range communication schemes such as Bluetooth or IEEE 802.11 in a discovery procedure involving devices under deep sleep. Furthermore, it is relevant for 3GPP-based technologies, either via sidelink and relay or directly from a (local) base station. The larger the coverage area of the discovery, the more important to minimize wasted energy in devices not relevant for the requested service, function, or device type making embodiments of the present disclosure even more important.

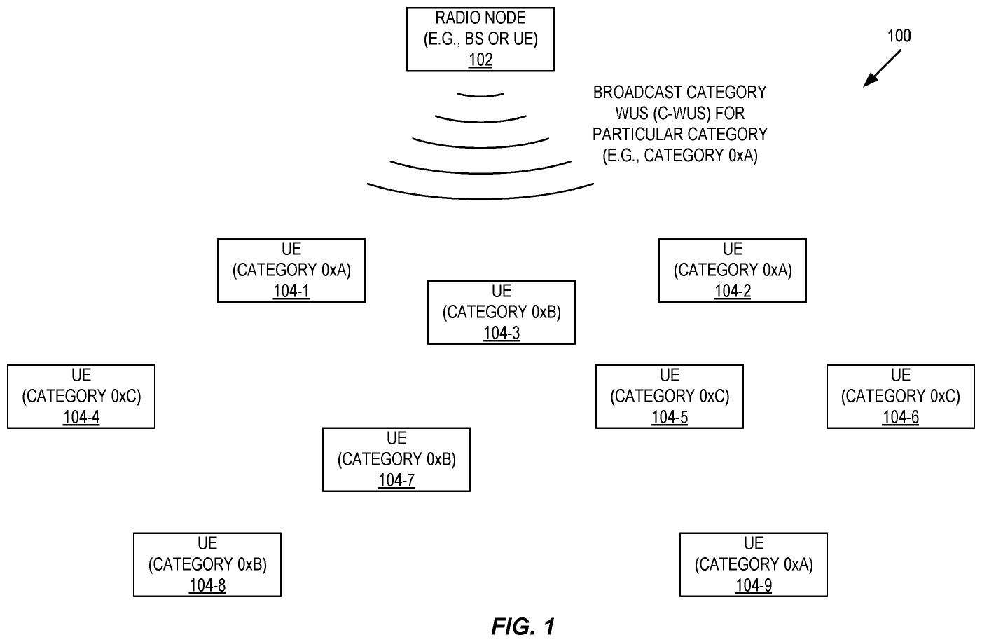

FIG. 1 illustrates one example of a system 100 in which embodiments of the present disclosure may be implemented. As illustrated, the system 100 includes a radio node 102 and multiple UEs 104. In one embodiment, the radio node 102 is RAN node such as, e.g., a base station (e.g., an eNB or gNB), gNB-DU, or gateway in a 3GPP network. In another embodiment, the radio node 102 is a UE (e.g., a relay UE). In this example, there nine UEs are shown and referred to as UEs 104-1 to 104-9. Note, however, that the UEs 104-1 to 104-9 are generally referred to herein collectively as UEs 104 and individually as UE 104. In the illustrated example, the UEs 104 include UEs 104-1, 104-2, and 104-9 that are in a first category (denoted in FIG. 1 as Category 0xA), UEs 104-3, 104-7, and 104-8 that are in a second category (denoted in FIG. 1 as Category 0xB), and UEs 104-4, 104-5, and 104-6 that are in a third category (denoted in FIG. 1 as Category 0xB). Note that while three categories are used in the example of FIG. 1, there may be any number of two or more categories. Further, each category may include any number of one or more (but preferably two or more) UEs 104. In one embodiment, each UE 104 is only in one category; however, in an alternative embodiment, a UE 104 may belong to more than one category. The UEs 104 are in a deep sleep (e.g., idle state in a 3GPP network).

In operation, the radio node 102 transmits (e.g., broadcasts) a Category-based Wake-Up Signal (C-WUS) for wake-up of a particular category of UEs 104. In the illustrated example, the C-WUS is for wake-up of Category 0xA. The C-WUS is not for wake-up of UEs 104 in any of the other categories. The manner in which the C-WUS indicates the particular category can vary depending on the particular embodiment. In one embodiment, one or more characteristics (e.g., the waveform) of the C-WUS indicate the particular category. In another embodiment, the C-WUS is encoded with a category identity (ID) of the particular category. While in deep sleep, each of the UEs 104 monitors for a C-WUS for its respective category. In this example, the UEs 104-1, 104-2, and 104-9 are in the particular category (Category 0xA) indicated by the C-WUS and, as such, the UEs 104-1, 104-2, and 104-9 detect the C-WUS and, in response thereto, wake-up and transmit an ACK (or optionally transmit their UE IDs) back to the radio node 102. The other UEs 104-3 to 104-8 do not wake-up since the C-WUS is not for their respective categories.

Note that the definition of a UE “category” can vary with different implementations of the embodiments of the C-WUS signaling mechanism described herein. While some example categories are described herein, one of ordinary skill in the art will understand that there are numerous examples of UE categories, any of which may be used for the C-WUS signaling mechanism described herein.

In one embodiment, the UE categories are defined based on functional categories, service categories, and/or device types. Examples are provided below, but there are many other types of categories possible with many more types of UEs possible today and in the future. These examples are:
Functional categories, e.g.:
   Media-related (e.g., Headphones, speakers, imaging)
   Building-related measuring sensors (e.g., energy, water, humidity, gas)
   Locks (e.g., door locks, window locks)
   Home automation (e.g., light bulbs, electrical outlets, window shades, window blinds, thermostats, etc.)
   Information Technologies (IT) peripherals (e.g., wireless keyboard, mouse, whiteboard, etc.)
Service categories
   Play audio (speakers, headphones)
   Measure energy (different sensors in a building)
   Measure pollution (different types of gas sensors, or activities of certain machines)
   Support laptop (speakers, mouse, keyboard, etc.)
Device-types:
   Ultra-low power sensors (energy, etc.)
   Functional devices with low wake-up latency, low bit-rate, frequent wake-up (locks, etc.)
   Devices with long operational activity but long deep-sleep periods (keyboards, mouse, etc.)
Service Provider Categories
   E.g., separate categories for service providers A, B, C, etc.
Vender (e.g., UE vender categories)
   E.g., separate categories for UE venders A, B, C, etc.
User or Owner Categories
   In one embodiment, the number of categories defined is such that there are enough categories to enable targeted wake-up of only those UEs 104 that are related to the particular function, service, or device-type desired for wake-up. In one embodiment, one or more of the categories may be defined by one or more third-parties.

In one embodiment, for a certain category, the C-WUS is designed with a specific waveform (e.g., a signal with a specific pattern), where the C-WUS having this specific waveform indicates that the wake-up is for that certain category. For a UE 104 belonging to that category, the waveform is used as a reference which can be pre-stored in the UE 104, e.g., either during production or during deployment. A low-power radio in the UE 104 receives the C-WUS transmitted from the radio node 102 and perform match filtering to the pre-stored reference. If the waveform of the C-WUS matches the reference, i.e. the C-WUS for the respective category is detected, the UE 104 wakes-up and sends an ACK (or optionally sends its UE ID) back to the radio node 102.

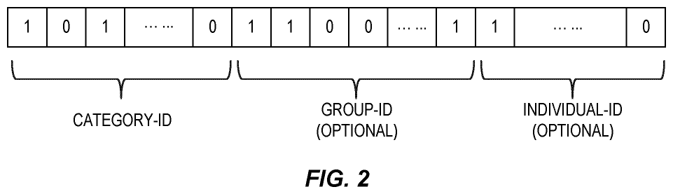

In another embodiment, the C-WUS is modulated or encoded with a specific category ID corresponding to the category. In one embodiment, for the UE 104, the category ID is part of its UE, or device, ID. The UE ID can, for example, be either pre-set during production or set during deployment. FIG. 2 shows an example of device ID consisting of category ID, group ID, and individual ID in accordance with one embodiment of the present disclosure. Note that FIG. 2 provides an example where there are three fields. In other embodiments, there might be two fields (Category-ID and Individual-ID), and in certain cases there might only be the Category-ID. In one embodiment, a low-power radio in the UE 104 receives the C-WUS and demodulates or decodes the C-WUS to extract the category ID. If the UE 104 finds that the decoded category ID carried by the C-WUS is the same as its own category ID, the UE 104 wakes-up and sends an ACK (or optionally send its device ID) back to the radio node 102.

In one embodiment, for a UE 104, the start of C-WUS detection is triggered by Radio Frequency (RF) power measurement on the frequency spectrum in which C-WUS is to be performed. For instance, low-power radio circuitry of the UE 104 can keep monitoring and measuring RF power on the frequency spectrum. Once the measured power is above a certain threshold, the UE 104 performs match filtering on the received signal to check if the received signal is a C-WUS for the UE's respective category.

It should be noted that since different categories of UEs 104 can have different needs, depending on how the categories are defined, the wake-up procedure after the initial C-WUS can differ between different categories. For example, certain UEs 104 might have demands on short wake-up latency but very relaxed synchronization needs and bit rates, whereas others have demands on very strict synchronization needs and will support higher bit-rates. Since the radio node 102 that initiates the wake-up procedure of a certain category of UEs 104, as well as the UEs 104 in that category, knows about typical characteristics of the target category, the procedure can be optimized accordingly instead of being general to match all possible device categories.

C-WUS signaling can be used in many different scenarios. One is to fully wake-up and activate a certain set of UEs 104 in the area, where later communication with those UEs 104 depends on what types of services or functions are needed, and those UEs 104 that are woken up but no longer are required are commanded to go into deep sleep.

However, in another embodiment, the C-WUS is used as part of a discovery procedure. In this case, the wake-up procedure might proceed in multiple pre-defined steps. This is further described below.

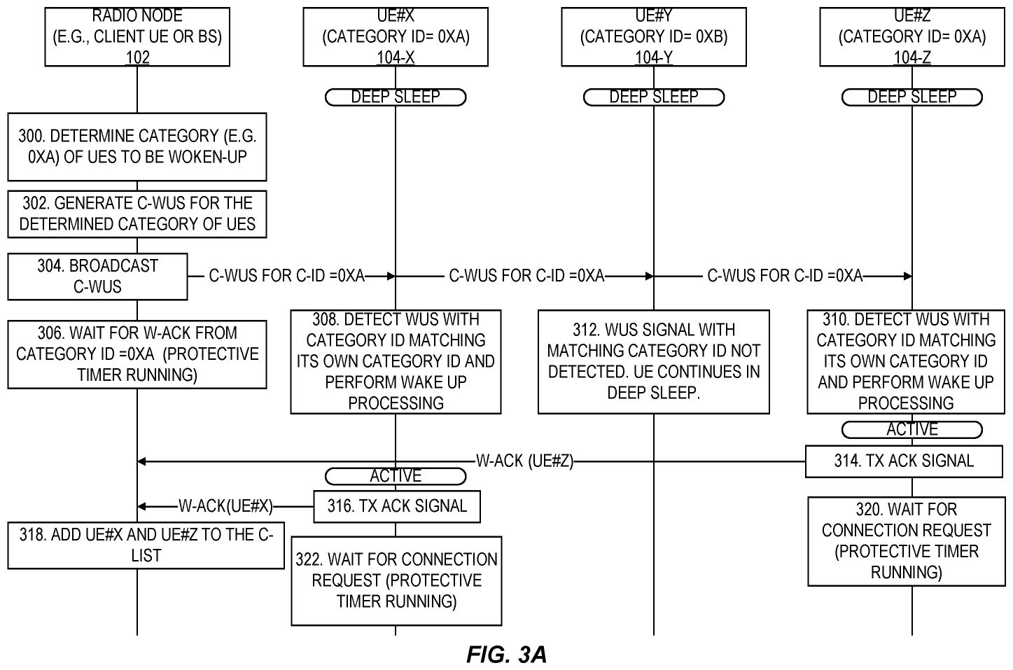

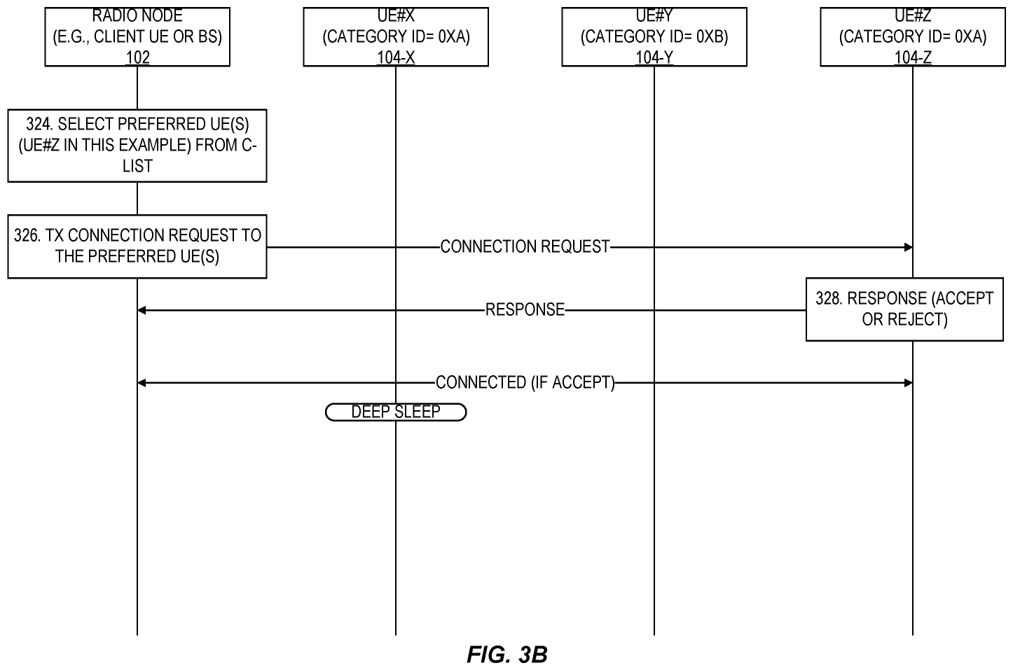

In this regard, FIGS. 3A and 3B illustrate a category-based wake-up and discovery procedure in accordance with one embodiment of the present disclosure. Initially, the UEs 104 are in deep sleep. In this example, only three UEs are shown for clarity and ease of discussion. These UEs are denoted as UEs 104-x, 104-y, and 104-z. The radio node 102 determines a category of UEs 104 that is to be woken-up (step 300), generates a C-WUS for the determined category of UEs 104 (step 302), and broadcasts the generated C-WUS (step 304). In this example, the determined category is Category 0xA (i.e., the category ID is 0xA). In one embodiment, the radio node 102 is a client UE (C-UE), and the C-UE, based on an application executing at the C-UE or user trigger, determines the category of UEs 104 that is to be woken-up, looks up the category ID, and passes the category ID to a lower layer in the Open Systems Interconnection (OSI) stack, such as the physical layer, to generate the corresponding unique discovery and wake up signal for the category of UEs 104. This unique discovery and wake-up signal for the category of UEs is the C-WUS described herein. In another embodiment, the radio node 102 is a RAN node (e.g., a base station), and the base station determines the category of UEs 104 to be woken-up or discovered based on, e.g., signaling or request from another network node. This signaling or request may, for example include the category ID of the category of UEs 104 to be woken-up or discovered. In step 302, the C-WUS is, in one embodiment, pre-generated and stored, e.g., in a look up table. In another embodiment, the C-WUS is dynamically generated as needed. In one embodiment, an ID of the radio node 102 is omitted from the C-WUS; however, in an alternative embodiment, the C-WUS may also indicate the ID of the radio node 102.

After broadcasting the C-WUS, the radio node 102 monitors for ACKs from the UEs 104 in the category indicated by the C-WUS (step 306). In this example, the UE 104-x and the UE 104-z belong to the category indicated by the C-WUS. As such, the UEs 104-x and 104-z detect the C-WUS and wake-up (steps 308 and 310). In contrast, the UE 104-y does not belong to the category and, as such, does not detect the C-WUS and thus continues in deep sleep (step 312). Note that the wake-up processing times of each of the UEs 104-x and Q104-z could be different and hence the radio node 104 might, as part of step 306, start a protective timer to exit the waiting state for ACKs. Once the UEs 104-x and 104-z are woken-up (i.e., once they have entered an active state), they transmit wake-up acknowledgment signals (W-ACKs) (steps 314 and 316). In one embodiment, the W-ACK transmitted by the UE 104-x includes a UE ID of the UE 104-x, and the W-ACK transmitted by the UE 104-z includes a UE ID of the UE 104-z.

In one embodiment, responsive to receiving the W-ACKs, the radio node 102 adds the UEs 104-x and 104-z to a candidate list (C-List) (step 318). Further, upon transmitting the W-ACKs in steps 314 and 316, the UEs 104-x and 104-z wait for a connection request from the radio node 102 (steps 320 and 322). The UEs 104-x and 104-z may wait for a period of time within which they can be connected to before going back to deep sleep. This is a waiting time for receiving connection request from the radio node 102, and the UEs 104-x and 104-z are not connected until they receive connection request and accept that request. This period of time may be predefined or preconfigured.

Based on some pre-determined information such as the number of UEs to connect to, the radio node 102 selects a set of preferred UEs (denoted herein as “P-UEs”) from the candidate list (C-List) of discovered UEs (step 324) sends a connection request to each of the P-UEs (step 326). In this example, the UE 104-z is the P-UE. In one embodiment, the preferred UE(s) is(are) selected based on one or more criteria such as, e.g., received signal strength, battery status, order in which the corresponding W-ACKs were received from the UEs in the C-List (e.g., select the UE that responded with a W-ACK first as the P-UE), or the like, or any combination thereof. It should be noted that the candidate list may include additional UEs (e.g., UEs that were already in active state and discovered via a discovery procedure). The P-UE, which in this example is the UE 104-z, responds to the connection request from the radio node 102 (step 328). The response to the connection request may indicate that the UE 104-z accepts the connection request or rejects the connection request. If accepted, the connection is then established between the radio node 102 and the UE 104-z. Other UEs in the C-List go back to deep sleep, e.g., after the timer defining the wait period has expired. Also, if any P-UE rejected the connection request, then that P-UE would go back to deep sleep, e.g., after the wait timer has expired.

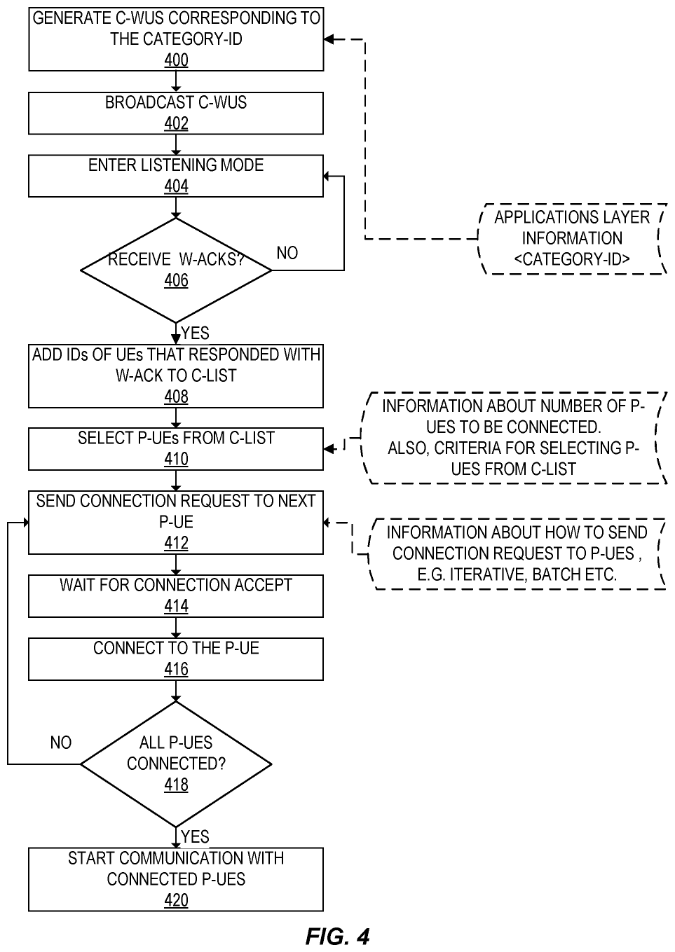

FIG. 4 is a flow chart that illustrates the operation of the radio node 102 in accordance with one embodiment of the present disclosure. This process corresponds to the process performed by the radio node 102 (starting at step 302) in the overall procedure of FIGS. 3A and 3B. As illustrated, the radio node 102 generates and broadcasts a C-WUS for a particular category of UEs 104 (i.e., the category having a particular category ID) (steps 400 and 402). The radio node 102 then enters a listening mode in which it monitors for W-ACKs from the UEs 104 in the particular category (step 404). While in the listening mode, the radio node 102 determines whether it has received any W-ACKs from the UEs 104 in the particular category in response to the C-WUS (step 406). If not, the radio node 102 continues to listen, e.g., until a predefined or preconfigured timer has expired. The radio node 102 adds the UE IDs of the UEs 104 from which W-ACKs are received to the C-List (step 408).

The radio node 102 selects one or more P-UEs from the C-List (step 410). As discussed above, this selection may consider one or more criteria. The selected P-UEs are UEs 104 in the particular category to which the radio node 102 is to request a connection. The radio node 102 sends a connection requests to the P-UEs and connects to those P-UEs that accept the connection request. More specifically, in this embodiment, the radio node 102 sends a connection request to the next P-UE (which for the first iteration is the first P-UE) (step 412), waits for a response from the P-UE (414), and connects to the P-UE upon receiving a response (assuming that the P-UE accepts the connection request) (step 416). The radio node 102 determines whether connection requests have been sent to all of the P-UEs (step 418). If not, the process returns to step 412 and is repeated for the next P-UE. In this example, once connection requests have been sent to all of the P-UEs, the radio node 102 starts communication with the P-UEs (step 420).

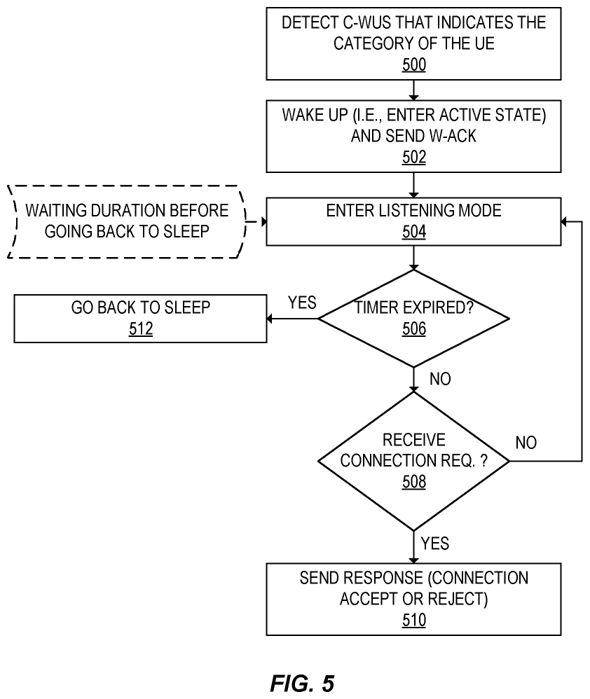

FIG. 5 is a flow chart that illustrates the operation of a UE 104 in accordance with one embodiment of the present disclosure. This process corresponds to the process performed by each of the UEs 104-x, 104-y, and 104-z in the overall procedure of FIGS. 3A and 3B. As illustrated, the UE 104 detects a C-WUS indicative of a category ID that matches its own category ID (step 500). In response to detecting the C-WUS, the UE 104 wakes-up from the deep sleep state (i.e., enters an active state) and transmits a W-ACK to the radio node 102 (step 502). The UE 104 then enters a listening mode in which the UE 104 listens for a connection request from the radio node 102 (step 504). Upon entering the listening mode, a timer is started, where the timer defines the amount of time that the UE 104 is to wait for a connection request from the radio node 102. While in the listening mode, the UE 104 determines whether the timer has expired (step 506). If not, the UE 104 determines whether it has received a connection request from the radio node 102 (step 508). If not, process returns to step 504 and the UE 104 continues to wait for a connection request. If the UE 104 has received a connection request, the UE 104 transmits a connection response to the radio node 102 (step 510). The connection response can be either a connection acceptance or a connection rejection. Returning to step 506, if the timer expires before the UE 104 has received a connection request, the UE 104 returns to the deep sleep state (step 512).

The embodiments above focus on C-WUS signaling. However, in another embodiment where Group-ID and Individual-ID are used in addition to Category-ID (e.g., as in FIG. 2), multiple wake-up signals may be transmitted to cause the UE 104 to progressively enter into lighter and lighter sleep modes where the UE 104 waits for a predetermined or preconfigured amount of time (e.g., defined specifically for each mode) to determine whether the next WUS is received before going back to deeper sleep mode. For example, the radio node 102 may first transmit the C-WUS for a particular category of UEs and then transmits a group WUS (G-WUS) for a particular group of UEs. The G-WUS is indicative of the particular group (i.e., the group-ID). For example, the G-WUS may have a waveform that is unique to the group or may be encoded with the Group-ID. At the UE 104, if the UE 104 is in the particular category, the UE 104 detects the C-WUS and then enters a mode in which the UE 104 monitors for a G-WUS for a particular group in which the UE 104 is included. If the UE 104 is in the particular group for which the radio node 102 transmits the G-WUS, the UE 104 detects the G-WUS. Upon detecting the G-WUS for its group, the UE 104 then, for example, transmits a W-ACK to the radio node 102 and enters a listening mode in which it listens for a connection request from the radio node 102, as described above. If the UE 102 is not in the particular group for which the radio node 102 transmits the G-WUS, the UE 104 does not detect the G-WUS and re-enters the deep sleep mode (e.g., after expiry of an associated timer). Note that while only a category ID and group ID are used in the example above, there may be additional levels of IDs (e.g., subgroup ID, etc.) corresponding to additional WUSs. Upon detecting each WUS before expiry of an associated timer, the UE 104 enters the next (lighter) sleep mode until the UE 104 eventually is woken-up. However, if at any level the UE 104 does not detect the associated WUS, the UE 104 may either return to the previous (deeper) sleep mode or return to the deep sleep mode.

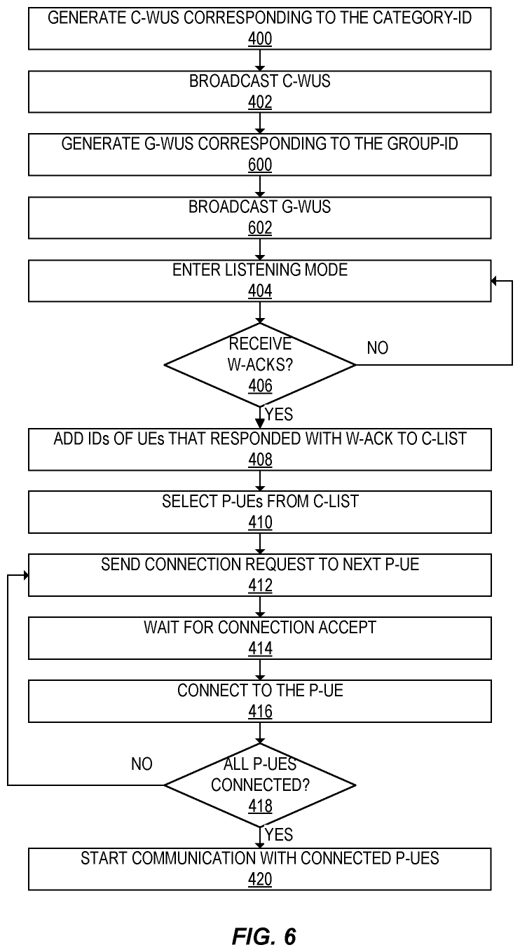

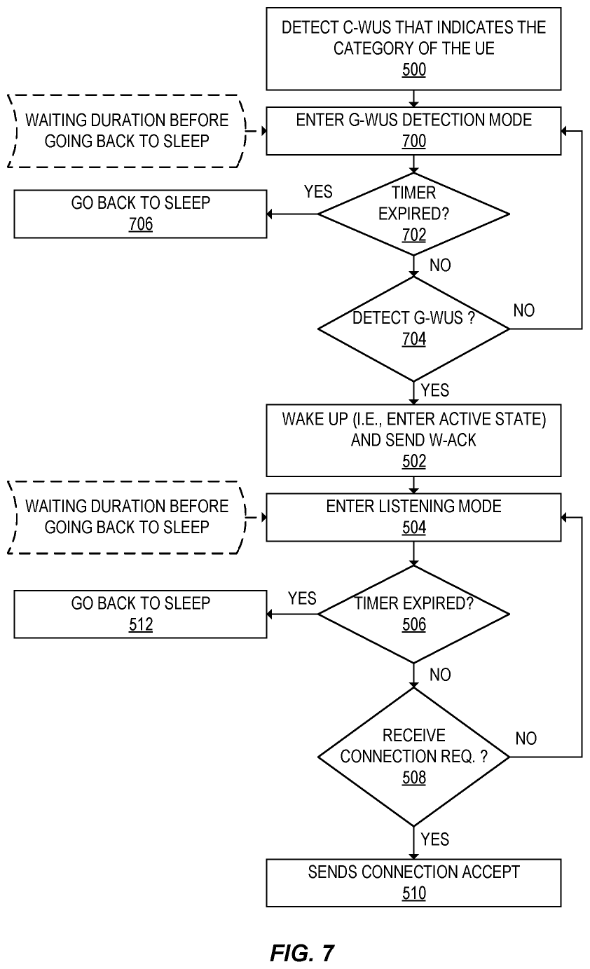

One example of the multiple level wake-up scheme described above is illustrated in FIGS. 6 and 7. FIG. 6 is a modified version of the flow chart of FIG. 4 showing the operation of the radio node 102 to transmit the C-WUS and a G-WUS in accordance with one embodiment of the present disclosure. The combination of the C-WUS and the G-WUS results in wake-up of the UEs 104 that are both in the category indicated by the C-WUS and in the group indicated by the G-WUS. As illustrated, after transmission of the C-WUS in step 402, the radio node 102 generates the G-WUS for a particular group (step 600), broadcasts the G-WUS (step 602), and then enters the listening mode of step 404 to listen for W-ACKs. However, in contrast to the procedure of FIG. 4, the W-ACKs are received only from UEs 104 that are both in the particular category and in the particular group. In other words, the UEs 104 from which the W-ACKs are received are the subset of the UEs 104 in the particular category that are also in the particular group. The process then proceeds as described above.

FIG. 7 is a modified version of the flow chart of FIG. 5 showing the operation of the UE 104 to perform progressive wake-up based on detection of the C-WUS and a G-WUS in accordance with one embodiment of the present disclosure. The combination of the C-WUS and the G-WUS results in wake-up of the UE 104 only if the UE 104 is both in the category indicated by the C-WUS and in the group indicated by the G-WUS. As illustrated, after detecting the C-WUS in step 500, the UE 104 enters a G-WUS detection mode in which the UE 104 attempts to detect a G-WUS for the respective group in which the UE 104 is included for an amount of time defined by an associated timer (steps 700 and 702). If the UE 104 detects a G-WUS for the respective group before the timer has expired (step 702, NO and step X604, YES), the UE 104 wakes-up (i.e., enters active state) and sends a W-ACK (step 502) and the procedure proceeds as described above with respect FIG. 5. However, if the UE 104 does not detect a G-WUS for the respective group before the timer has expired (step 702, YES), the UE 104 re-enters the deep sleep mode (step 706).

In the example embodiments described above, the radio node 102 uses the W-ACKs received from the UEs 104 in the category (and possibly group) indicated by the C-WUS (and possibly G-WUS) to provide the C-List of candidate UEs from which the radio node 102 selects one or more p-UEs to which to connect. However, in other embodiments, the radio node 102 uses the received W-ACKs to discover all of the UEs 104 that are in a particular category (and possibly group) and then send a report to a network node (e.g., base station or some other RAN node). A use-case scenario for this is where a remote application wants to discover all available UEs belonging to a certain category and then send a request to the radio node 102, which acts as a relay to one or more target, or preferred, UEs from that category. The number of such target UEs that then get a connection request could be less than all discovered UEs. Alternative, the discovery was only to gain understanding of the number of UEs in the area that are in that category, and none of them get a connection request. In this case, the discovered UEs will go back to deep sleep.

The above mechanisms and procedures can apply to different types of systems. In one embodiment, the C-WUS is used in a 3GPP system allowing a base station (e.g., the radio node 102 is a base station in a 3GPP system) to identify which UEs 104 (e.g., IoT UEs) are in deep sleep in its coverage area, e.g., in order to form wake-up groups without having to wake up all of the UEs 104 in the area.

In another embodiment, rather than waking up the UEs 104 in a particular category, the C-WUS wake-up procedure is used to wake up all UEs 104 except those in one or more certain categories. For example, radio node 102 may loop through all categories except one or more categories of UEs 104 that are ultra-low power devices.

In one embodiment, certain categories are limited to certain specific services, e.g. utilities, and only certain specific personnel should have access to those. Then, such categories of UEs 104 might belong to restricted categories, and the system allows only C-WUS to other (unrestricted) categories. Only certain authorized radio nodes might be allowed to send C-WUS to the restricted categories. This means that there is less risk that different types of devices, or different types of services in base stations, risk waking up sensitive equipment with limited battery which they are not allowed to use.

In another embodiment, the C-WUS is used for 3GPP sidelink in order to establish connection with local UEs 104 that are relevant for the type of host device or types of function/service being requested. In this case, the radio node 102 is a UE.

Different types of discovery procedures can be defined based on the C-WUS mechanism. In one embodiment, the Bluetooth® discovery procedure is extended with a phase to also include devices under deep sleep. Then, a phase can include sending out relevant C-WUS for certain device classes in order to include also devices in deep sleep and not only those that are already active. Instead of sending C-WUS to all categories or all devices, a subset of categories relevant for the discovery can be based on:
the type of host may limit which types of devices are relevant to connect to, forming a short list of relevant categories
the supported Bluetooth® profiles might limit to certain relevant categories
the type of user might imply a limitation to the categories supported
etc.
   To be clear, the C-WUS in the Bluetooth® case would be an extension to the Bluetooth® standard, in which case it need not involve cellular C-WUS message for the wake-up phase. However, in one case, one might also consider a collaboration where a cellular C-WUS procedure supports a Bluetooth® discovery procedure.

Furthermore, a device might have a list of paired but not connected devices that have previously been in deep sleep but are not connected—the reason might be that they are in deep sleep and not that they are beyond reach. For such deep sleep paired devices, a discovery may imply sending a C-WUS plus an individual WUS (I-WUS) to those specific device-IDs to provide a sanity check as to whether they are within reach.

In another implementation, the discovery procedure is used for IEEE 802.11 based direct connection. Instead of having to explicitly turn-on potential devices or having those always-on, the C-WUS mechanism can be used for that step.

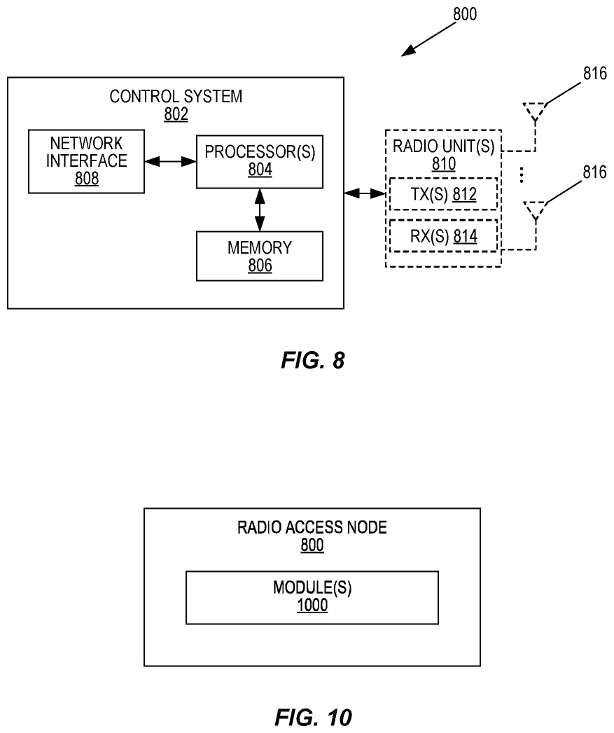

FIG. 8 is a schematic block diagram of a RAN node 800 according to some embodiments of the present disclosure. Optional features are represented by dashed boxes. The RAN node 800 may be, for example, one embodiment of the radio node 102 described herein. As illustrated, the RAN node 800 includes a control system 802 that includes one or more processors 804 (e.g., Central Processing Units (CPUs), Application Specific Integrated Circuits (ASICs), Field Programmable Gate Arrays (FPGAs), and/or the like), memory 806, and a network interface 808. The one or more processors 804 are also referred to herein as processing circuitry. In addition, the RAN node 800 may include one or more radio units 810 that each includes one or more transmitters 812 and one or more receivers 814 coupled to one or more antennas 816. The radio units 810 may be referred to or be part of radio interface circuitry. In some embodiments, the radio unit(s) 810 is external to the control system 802 and connected to the control system 802 via, e.g., a wired connection (e.g., an optical cable). However, in some other embodiments, the radio unit(s) 810 and potentially the antenna(s) 816 are integrated together with the control system 802. The one or more processors 804 operate to provide one or more functions of a RAN node 800 (e.g., the radio node 102) as described herein. In some embodiments, the function(s) are implemented in software that is stored, e.g., in the memory 806 and executed by the one or more processors 804.

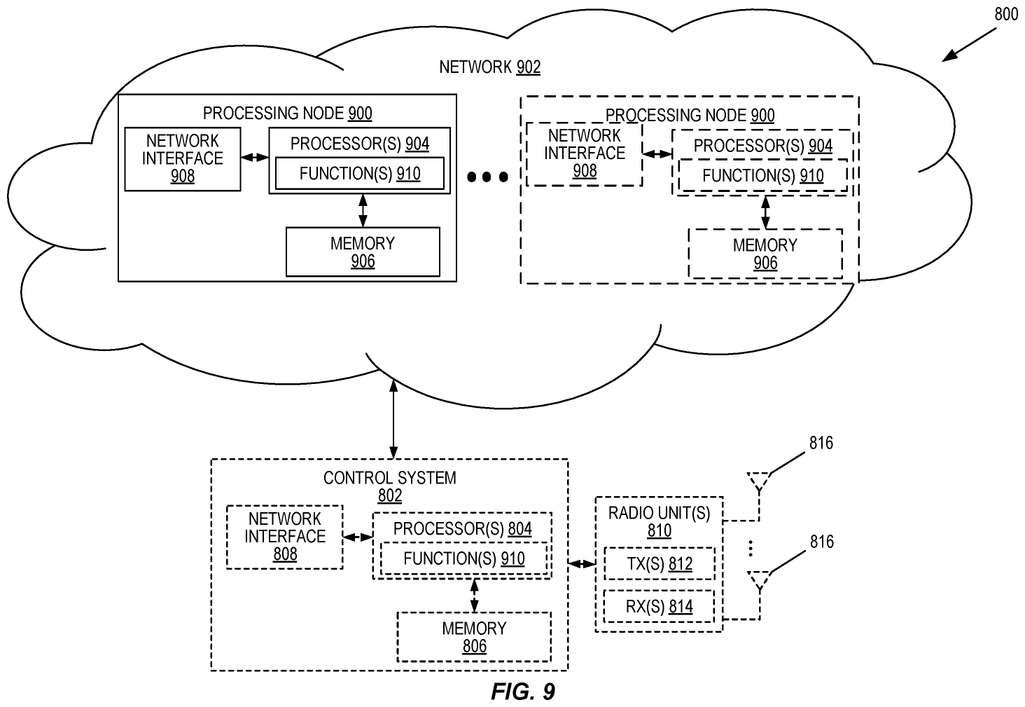

FIG. 9 is a schematic block diagram that illustrates a virtualized embodiment of the RAN node 800 according to some embodiments of the present disclosure. This discussion is equally applicable to other types of network nodes. Further, other types of network nodes may have similar virtualized architectures. Again, optional features are represented by dashed boxes.

As used herein, a “virtualized” RAN node is an implementation of the RAN node 800 in which at least a portion of the functionality of the RAN node 800 is implemented as a virtual component(s) (e.g., via a virtual machine(s) executing on a physical processing node(s) in a network(s)). As illustrated, in this example, the RAN node 800 may include the control system 802 and/or the one or more radio units 810, as described above. The control system 802 may be connected to the radio unit(s) 810 via, for example, an optical cable or the like. The RAN node 800 includes one or more processing nodes 900 coupled to or included as part of a network(s) 902. If present, the control system 802 or the radio unit(s) are connected to the processing node(s) 900 via the network 902. Each processing node 900 includes one or more processors 904 (e.g., CPUs, ASICs, FPGAs, and/or the like), memory 906, and a network interface 908.

In this example, functions 910 of the RAN node 800 described herein are implemented at the one or more processing nodes 900 or distributed across the one or more processing nodes 900 and the control system 802 and/or the radio unit(s) 810 in any desired manner. In some particular embodiments, some or all of the functions 910 of the RAN node 800 described herein are implemented as virtual components executed by one or more virtual machines implemented in a virtual environment(s) hosted by the processing node(s) 900. As will be appreciated by one of ordinary skill in the art, additional signaling or communication between the processing node(s) 900 and the control system 802 is used in order to carry out at least some of the desired functions 910. Notably, in some embodiments, the control system 802 may not be included, in which case the radio unit(s) 810 communicate directly with the processing node(s) 900 via an appropriate network interface(s).

In some embodiments, a computer program including instructions which, when executed by at least one processor, causes the at least one processor to carry out the functionality of RAN node 800 or a node (e.g., a processing node 900) implementing one or more of the functions 910 of the RAN node 800 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 10 is a schematic block diagram of the RAN node 800 according to some other embodiments of the present disclosure. The RAN node 800 includes one or more modules 1000, each of which is implemented in software. The module(s) 1000 provide the functionality of the RAN node 800 described herein. This discussion is equally applicable to the processing node 900 of FIG. 9 where the modules 1000 may be implemented at one of the processing nodes 900 or distributed across multiple processing nodes 900 and/or distributed across the processing node(s) 900 and the control system 802.

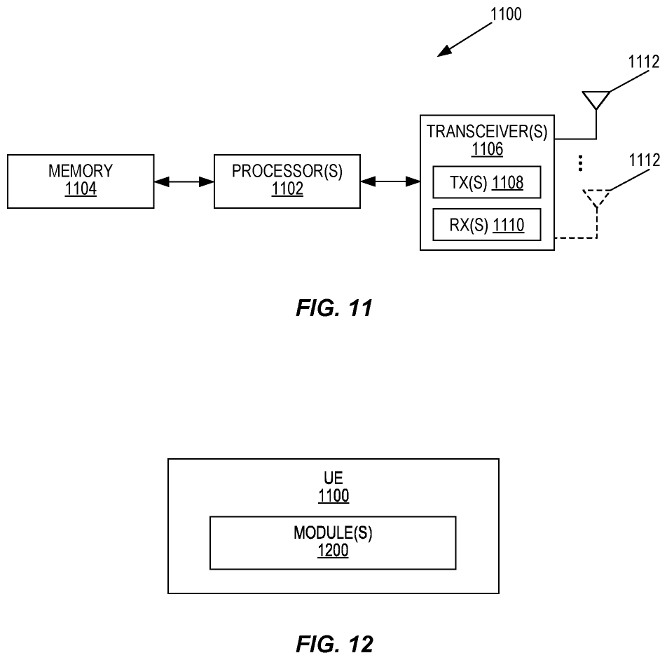

FIG. 11 is a schematic block diagram of a UE 1100 according to some embodiments of the present disclosure. As illustrated, the UE 1100 includes one or more processors 1102 (e.g., CPUs, ASICs, FPGAs, and/or the like), memory 1104, and one or more transceivers 1106 each including one or more transmitters 1108 and one or more receivers 1110 coupled to one or more antennas 1112. The transceiver(s) 1106 includes radio-front end circuitry connected to the antenna(s) 1112 that is configured to condition signals communicated between the antenna(s) 1112 and the processor(s) 1102, as will be appreciated by on of ordinary skill in the art. The processors 1102 are also referred to herein as processing circuitry. The transceivers 1106 are also referred to herein as radio circuitry. In some embodiments, the functionality of the UE 1100 described above may be fully or partially implemented in software that is, e.g., stored in the memory 1104 and executed by the processor(s) 1102. Note that the UE 1100 may include additional components not illustrated in FIG. 11 such as, e.g., one or more user interface components (e.g., an input/output interface including a display, buttons, a touch screen, a microphone, a speaker(s), and/or the like and/or any other components for allowing input of information into the UE 1100 and/or allowing output of information from the UE 1100), a power supply (e.g., a battery and associated power circuitry), etc.

In some embodiments, a computer program including instructions which, when executed by at least one processor, causes the at least one processor to carry out the functionality of the UE 1100 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the UE 1100 according to some other embodiments of the present disclosure. The UE 1100 includes one or more modules 1200, each of which is implemented in software. The module(s) 1200 provide the functionality of the UE 1100 described herein.

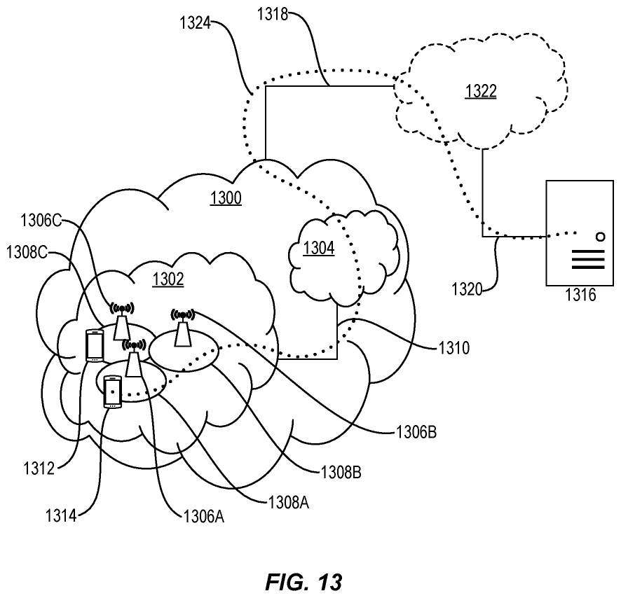

With reference to FIG. 13, in accordance with an embodiment, a communication system includes a telecommunication network 1300, such as a 3GPP-type cellular network, which comprises an access network 1302, such as a RAN, and a core network 1304. The access network 1302 comprises a plurality of base stations 1306A, 1306B, 1306C, such as Node Bs, eNBs, gNBs, or other types of wireless Access Points (APs), each defining a corresponding coverage area 1308A, 1308B, 1308C. Each base station 1306A, 1306B, 1306C is connectable to the core network 1304 over a wired or wireless connection 1310. A first UE 1312 located in coverage area 1308C is configured to wirelessly connect to, or be paged by, the corresponding base station 1306C. A second UE 1314 in coverage area 1308A is wirelessly connectable to the corresponding base station 1306A. While a plurality of UEs 1312, 1314 are illustrated in this example, the disclosed embodiments are equally applicable to a situation where a sole UE is in the coverage area or where a sole UE is connecting to the corresponding base station 1306.

The telecommunication network 1300 is itself connected to a host computer 1316, which may be embodied in the hardware and/or software of a standalone server, a cloud-implemented server, a distributed server, or as processing resources in a server farm. The host computer 1316 may be under the ownership or control of a service provider, or may be operated by the service provider or on behalf of the service provider. Connections 1318 and 1320 between the telecommunication network 1300 and the host computer 1316 may extend directly from the core network 1304 to the host computer 1316 or may go via an optional intermediate network 1322. The intermediate network 1322 may be one of, or a combination of more than one of, a public, private, or hosted network; the intermediate network 1322, if any, may be a backbone network or the Internet; in particular, the intermediate network 1322 may comprise two or more sub-networks (not shown).

The communication system of FIG. 13 as a whole enables connectivity between the connected UEs 1312, 1314 and the host computer 1316. The connectivity may be described as an Over-the-Top (OTT) connection 1324. The host computer 1316 and the connected UEs 1312, 1314 are configured to communicate data and/or signaling via the OTT connection 1324, using the access network 1302, the core network 1304, any intermediate network 1322, and possible further infrastructure (not shown) as intermediaries. The OTT connection 1324 may be transparent in the sense that the participating communication devices through which the OTT connection 1324 passes are unaware of routing of uplink and downlink communications. For example, the base station 1306 may not or need not be informed about the past routing of an incoming downlink communication with data originating from the host computer 1316 to be forwarded (e.g., handed over) to a connected UE 1312. Similarly, the base station 1306 need not be aware of the future routing of an outgoing uplink communication originating from the UE 1312 towards the host computer 1316.

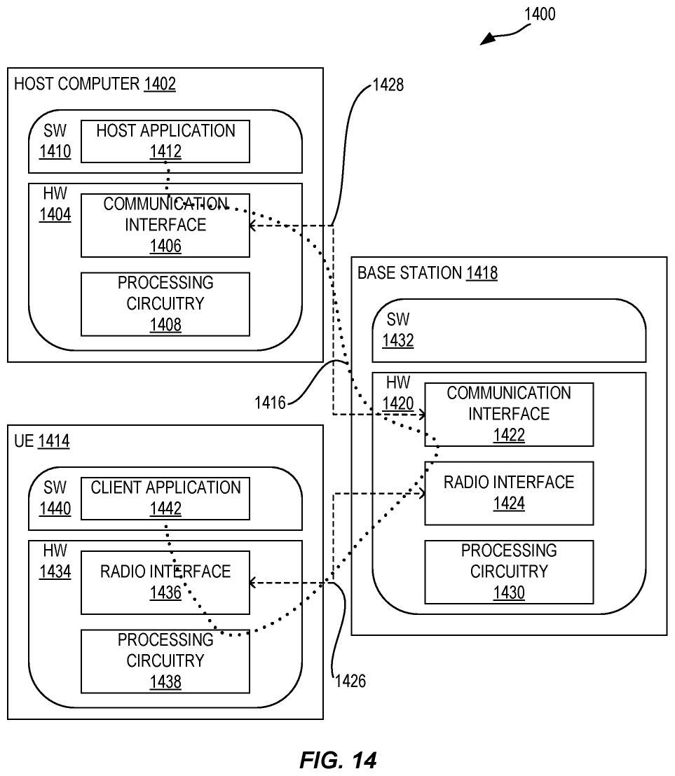

Example implementations, in accordance with an embodiment, of the UE, base station, and host computer discussed in the preceding paragraphs will now be described with reference to FIG. 14. In a communication system 1400, a host computer 1402 comprises hardware 1404 including a communication interface 1406 configured to set up and maintain a wired or wireless connection with an interface of a different communication device of the communication system 1400. The host computer 1402 further comprises processing circuitry 1408, which may have storage and/or processing capabilities. In particular, the processing circuitry 1408 may comprise one or more programmable processors, ASICs, FPGAs, or combinations of these (not shown) adapted to execute instructions. The host computer 1402 further comprises software 1410, which is stored in or accessible by the host computer 1402 and executable by the processing circuitry 1408. The software 1410 includes a host application 1412. The host application 1412 may be operable to provide a service to a remote user, such as a UE 1414 connecting via an OTT connection 1416 terminating at the UE 1414 and the host computer 1402. In providing the service to the remote user, the host application 1412 may provide user data which is transmitted using the OTT connection 1416.

The communication system 1400 further includes a base station 1418 provided in a telecommunication system and comprising hardware 1420 enabling it to communicate with the host computer 1402 and with the UE 1414. The hardware 1420 may include a communication interface 1422 for setting up and maintaining a wired or wireless connection with an interface of a different communication device of the communication system 1400, as well as a radio interface 1424 for setting up and maintaining at least a wireless connection 1426 with the UE 1414 located in a coverage area (not shown in FIG. 14) served by the base station 1418. The communication interface 1422 may be configured to facilitate a connection 1428 to the host computer 1402. The connection 1428 may be direct or it may pass through a core network (not shown in FIG. 14) of the telecommunication system and/or through one or more intermediate networks outside the telecommunication system. In the embodiment shown, the hardware 1420 of the base station 1418 further includes processing circuitry 1430, which may comprise one or more programmable processors, ASICs, FPGAs, or combinations of these (not shown) adapted to execute instructions. The base station 1418 further has software 1432 stored internally or accessible via an external connection.

The communication system 1400 further includes the UE 1414 already referred to. The UE's 1414 hardware 1434 may include a radio interface 1436 configured to set up and maintain a wireless connection 1426 with a base station serving a coverage area in which the UE 1414 is currently located. The hardware 1434 of the UE 1414 further includes processing circuitry 1438, which may comprise one or more programmable processors, ASICs, FPGAs, or combinations of these (not shown) adapted to execute instructions. The UE 1414 further comprises software 1440, which is stored in or accessible by the UE 1414 and executable by the processing circuitry 1438. The software 1440 includes a client application 1442. The client application 1442 may be operable to provide a service to a human or non-human user via the UE 1414, with the support of the host computer 1402. In the host computer 1402, the executing host application 1412 may communicate with the executing client application 1442 via the OTT connection 1416 terminating at the UE 1414 and the host computer 1402. In providing the service to the user, the client application 1442 may receive request data from the host application 1412 and provide user data in response to the request data. The OTT connection 1416 may transfer both the request data and the user data. The client application 1442 may interact with the user to generate the user data that it provides.

It is noted that the host computer 1402, the base station 1418, and the UE 1414 illustrated in FIG. 14 may be similar or identical to the host computer 1316, one of the base stations 1306A, 1306B, 1306C, and one of the UEs 1312, 1314 of FIG. 13, respectively. This is to say, the inner workings of these entities may be as shown in FIG. 14 and independently, the surrounding network topology may be that of FIG. 13.

In FIG. 14, the OTT connection 1416 has been drawn abstractly to illustrate the communication between the host computer 1402 and the UE 1414 via the base station 1418 without explicit reference to any intermediary devices and the precise routing of messages via these devices. The network infrastructure may determine the routing, which may be configured to hide from the UE 1414 or from the service provider operating the host computer 1402, or both. While the OTT connection 1416 is active, the network infrastructure may further take decisions by which it dynamically changes the routing (e.g., on the basis of load balancing consideration or reconfiguration of the network).

The wireless connection 1426 between the UE 1414 and the base station 1418 is in accordance with the teachings of the embodiments described throughout this disclosure. One or more of the various embodiments improve the performance of OTT services provided to the UE 1414 using the OTT connection 1416, in which the wireless connection 1426 forms the last segment.

A measurement procedure may be provided for the purpose of monitoring data rate, latency, and other factors on which the one or more embodiments improve. There may further be an optional network functionality for reconfiguring the OTT connection 1416 between the host computer 1402 and the UE 1414, in response to variations in the measurement results. The measurement procedure and/or the network functionality for reconfiguring the OTT connection 1416 may be implemented in the software 1410 and the hardware 1404 of the host computer 1402 or in the software 1440 and the hardware 1434 of the UE 1414, or both. In some embodiments, sensors (not shown) may be deployed in or in association with communication devices through which the OTT connection 1416 passes; the sensors may participate in the measurement procedure by supplying values of the monitored quantities exemplified above, or supplying values of other physical quantities from which the software 1410, 1440 may compute or estimate the monitored quantities. The reconfiguring of the OTT connection 1416 may include message format, retransmission settings, preferred routing, etc.; the reconfiguring need not affect the base station 1418, and it may be unknown or imperceptible to the base station 1418. Such procedures and functionalities may be known and practiced in the art. In certain embodiments, measurements may involve proprietary UE signaling facilitating the host computer's 1402 measurements of throughput, propagation times, latency, and the like. The measurements may be implemented in that the software 1410 and 1440 causes messages to be transmitted, in particular empty or ‘dummy’ messages, using the OTT connection 1416 while it monitors propagation times, errors, etc.

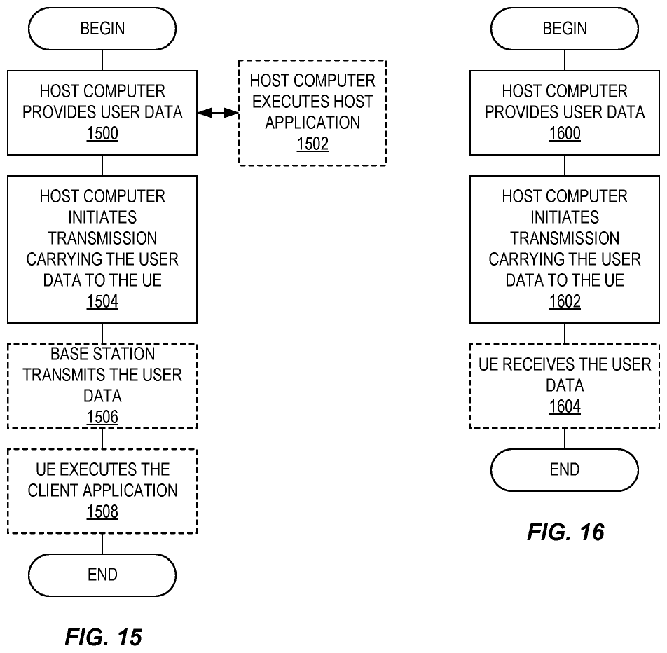

FIG. 15 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 15 will be included in this section. In step 1500, the host computer provides user data. In sub-step 1502 (which may be optional) of step 1500, the host computer provides the user data by executing a host application. In step 1504, the host computer initiates a transmission carrying the user data to the UE. In step 1506 (which may be optional), the base station transmits to the UE the user data which was carried in the transmission that the host computer initiated, in accordance with the teachings of the embodiments described throughout this disclosure. In step 1508 (which may also be optional), the UE executes a client application associated with the host application executed by the host computer.

FIG. 16 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 16 will be included in this section. In step 1600 of the method, the host computer provides user data. In an optional sub-step (not shown) the host computer provides the user data by executing a host application. In step 1602, the host computer initiates a transmission carrying the user data to the UE. The transmission may pass via the base station, in accordance with the teachings of the embodiments described throughout this disclosure. In step 1604 (which may be optional), the UE receives the user data carried in the transmission.

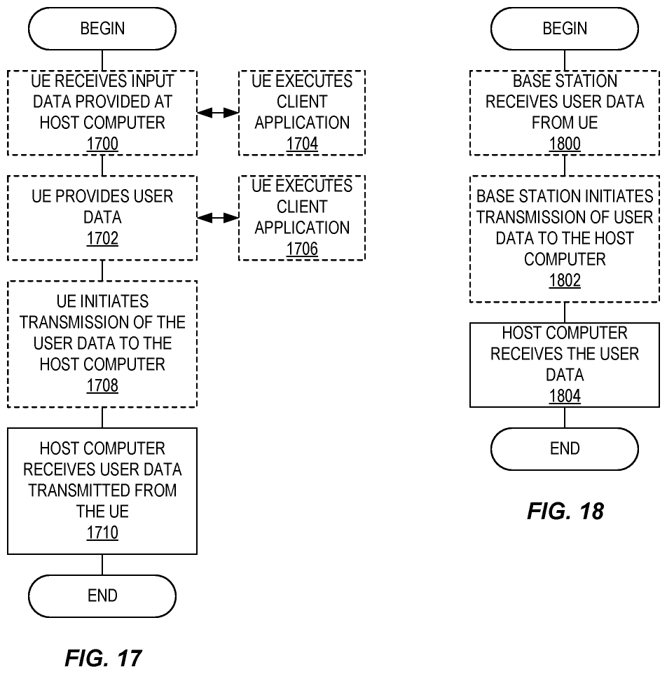

FIG. 17 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 17 will be included in this section. In step 1700 (which may be optional), the UE receives input data provided by the host computer. Additionally or alternatively, in step 1702, the UE provides user data. In sub-step 1704 (which may be optional) of step 1700, the UE provides the user data by executing a client application. In sub-step 1706 (which may be optional) of step 1702, the UE executes a client application which provides the user data in reaction to the received input data provided by the host computer. In providing the user data, the executed client application may further consider user input received from the user. Regardless of the specific manner in which the user data was provided, the UE initiates, in sub-step 1708 (which may be optional), transmission of the user data to the host computer. In step 1710 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 18 will be included in this section. In step 1800 (which may be optional), in accordance with the teachings of the embodiments described throughout this disclosure, the base station receives user data from the UE. In step 1802 (which may be optional), the base station initiates transmission of the received user data to the host computer. In step 1804 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a radio node, comprising:
determining a category of User Equipments, UEs, to be woken-up, the category of UEs being one of a plurality of predefined or preconfigured categories of UEs;
generating a category wake-up signal, C-WUS, that is indicative of the category of UEs to be woken-up; and
broadcasting the C-WUS.

2. The method of claim 1 wherein one or more characteristics of the C-WUS are indicative of the category of UEs to be woken-up.

3. The method of claim 1 wherein a waveform of the C-WUS is indicative of the category of UEs to be woken-up.

4. The method of claim 1 wherein the C-WUS is encoded or modulated with a category identifier, ID, of the category of UEs to be woken-up.

5. The method of claim 1 wherein the plurality of predefined or preconfigured categories of UEs comprise a plurality of functional categories of UEs.

6. The method of claim 5 wherein the one or more functional categories of UEs comprise: (a) one or more media-related categories, (b) one or more building-related measurement sensor categories, (c) one or more lock categories, (d) one or more home automation categories, (e) one or more Information Technology, IT, peripheral categories, or (f) a combination of any two or more of (a)-(e).

7. The method of claim 1 wherein the plurality of predefined or preconfigured categories of UEs comprise a plurality of service categories of UEs.

8. The method of claim 7 wherein the one or more service categories of UEs comprise: (i) one or more audio playback categories, (ii) one or more energy measurement categories, (iii) one or more pollution measurement categories, (iv) one or more computer support categories, or (v) a combination of any two or more of (i)-(v).

9. The method of claim 1 wherein the plurality of predefined or preconfigured categories of UEs comprise a plurality of device type categories.

10. The method of claim 9 wherein the one or more device type categories comprise: (A) a category of devices with ultra-low power, (B) a category of devices with low wake-up latency, low bit-rate, and frequent wake-up category, (C) a category of devices with long operational activity but long deep-sleep periods, or (D) a combination of any two or more of (A)-(C).

11. The method of claim 1 wherein the plurality of predefined or preconfigured categories of UEs comprises one or more vendor categories, one or more service provider categories, or one or more user or owner categories.

12. The method of claim 1 wherein the plurality of predefined or preconfigured categories of UEs comprises one or more third-party defined categories.

13. The method of claim 1 wherein the C-WUS is unique to the category of UEs to be woken-up.

14-16. (canceled)

17. The method of claim 1 further comprising:
generating a group wake-up signal, G-WUS, that is indicative of a group of UEs, the group of UEs being one of a plurality of predefined or preconfigured groups; and
broadcasting the G-WUS.

18. The method of claim 17 wherein:
one or more characteristics of the G-WUS are indicative of the group, or
a waveform of the G-WUS is indicative of the group; or
the G-WUS is encoded with a group identifier, ID, of the group of UEs.

19. (canceled)

20. (canceled)

21. The method of claim 17 further comprising:
monitoring for wake-up acknowledgments, W-ACKs, from UEs woken-up by the C-WUS and the G-WUS, the UEs woken-up by the C-WUS and the G-WUS being only those UEs that are both within the category and within the group; and
receiving W-ACKs from UEs woken-up by the C-WUS and the G-WUS;
adding the UEs from which the W-ACKs are received to a candidate list of UEs;
selecting one or more preferred UEs from the candidate list of UEs;
sending a connection request to each of the one or more preferred UEs; and
receiving a connection accept from at least one of the one or more preferred UEs.

22-24. (canceled)

25. The method of claim 1 wherein either:
the radio node is a base station in a cellular communications system, and the UEs are UEs in the cellular communications system; or
both the radio node and the UEs are UEs in a cellular communications system; or
both the radio node and the UEs are Bluetooth or IEEE 802.11 devices.

26-29. (canceled)

30. A radio node comprising:
one or more transmitters;
one or more receivers; and
processing circuitry associated with the one or more transmitters and the one or more receivers, the processing circuitry configured to cause the radio node to:
determine a category of User Equipments, UEs, to be woken-up, the category of UEs being one of a plurality of predefined or preconfigured categories of UEs;
generate a category wake-up signal, C-WUS, that is indicative of the category of UEs to be woken-up; and
broadcast the C-WUS.

31. (canceled)

32. A method performed by a User Equipment, UE, comprising:
while in a deep sleep state, detecting a category wake-up signal, C-WUS, from a radio node, the C-WUS being indicative of a category of UEs in which the UE is included; and
performing one or more actions responsive to detecting the C-WUS.

33-54. (canceled)

55. A User Equipment, UE, comprising:
one or more transmitters;
one or more receivers; and
processing circuitry associated with the one or more transmitters and the one or more receivers, the processing circuitry configured to cause the UE to:
while in a deep sleep state, detect a category wake-up signal, C-WUS, from a radio node, the C-WUS being indicative of a category of UEs in which the UE is included; and
perform one or more actions responsive to detecting the C-WUS.

56. (canceled)
